(19) United States
(12) Patent Application Publication
(10) Pub. No.: US 2025/0141058 A1
(43) Pub. Date: May 1, 2025

(54) METHOD FOR MANUFACTURING A BATTERY PACK

(71) Applicant: PLASTIC OMNIUM CLEAN ENERGY SYSTEMS RESEARCH, Lyon (FR)

(72) Inventors: Nicolas DERANGERE, Bruxelles (BE); Franck DHAUSSY, Bruxelles (BE)

(73) Assignee: PLASTIC OMNIUM CLEAN ENERGY SYSTEMS RESEARCH, Lyon (FR)

(21) Appl. No.: 18/730,501

(22) PCT Filed: Jan. 27, 2023
(86) PCT No.: PCT/EP2023/051973

§ 371 Date: Jul. 19, 2024

(30) Foreign Application Priority Data
Jan. 28, 2022 (FR) FR2200770

(51) Int. Cl. H01M 50/519; H01M 10/6555; H01M 50/211; H01M 50/284; H01M 50/516; H01M 50/536; H01M 50/548; H01M 50/557

(52) U.S. Cl. CPC H01M 50/519; H01M 10/6555; H01M 50/211; H01M 50/284; H01M 50/516; H01M 50/536; H01M 50/548; H01M 50/557

(57) ABSTRACT

A method for manufacturing a battery pack including a first cell package which is formed of at least one battery cell, a second cell package which is formed of at least one battery cell, and a printed circuit board, an electrically conductive strip being arranged between an electrode of a battery cell of a cell package and the printed circuit board, the electrically conductive strip being welded to the electrode at one end and to the printed circuit board at the other end, a central portion of the strip being curved, the two ends being planar and extending parallel to one another. A battery pack is obtained by the method, and a battery system includes at least two battery packs obtained thereby.

The invention relates to a method for manufacturing a battery pack, to such a battery pack, and to a battery system comprising two battery packs.

Already known in the prior art, for example from US 2020/0259157 A1 or US 2018/0175346 A1, is a battery pack comprising a plurality of battery modules each comprising pouch battery cells. Typically, in each battery module, the battery cells are stacked along a stacking axis and are electrically connected to one another by busbars, also extending along the stacking axis. However, these battery modules are relatively complex to manufacture and assemble, not least because the battery pouch cells deform by swelling and then deflating during successive charging and discharging cycles.

To overcome these disadvantages, it is known to produce battery sub-modules comprising a plurality of battery pouch cells. However, the assembly of these battery sub-modules is relatively complex, particularly with regard to the electrical connection of each battery cell to surrounding elements, such as a busbar and a printed circuit board, which is used in particular for monitoring and/or controlling the battery cells. It is necessary to position these elements precisely in relation to one another, and at the same time to compensate for the high stresses caused by the charging and discharging cycles, which may be applied to these elements as the battery cells swell and then deflate.

The object of the invention is especially to simplify the manufacture of a battery pack.

To this end, the invention relates to a method for manufacturing a battery pack, which comprises the following steps:
providing pouch battery cells, each battery cell comprising two electrodes facing one another,
creating a first cell package, which is formed of at least one battery cell,
creating a second cell package, which is formed of at least one battery cell,
aligning the first cell package and the second cell package, with one electrode of a battery cell of the first cell package and an opposite-sign electrode of a battery cell of the second cell package lying on top of one another, directly welding these two electrodes to one another, so that the first cell package and the second cell package are electrically connected in series, and folding the first cell package and the second cell package onto one another so that these two electrodes are folded,
providing a printed circuit board,
arranging an electrically conductive strip between one electrode of a battery cell of a cell package and the printed circuit board,
welding the electrically conductive strip at one end to the electrode and at the other end to the printed circuit board, a central portion of the strip being curved, the two ends being planar and extending parallel to one another.

A central portion of the strip is a portion of the strip located between the two ends of the strip. Because a central portion of the strip is curved, this compensates for the movement of the battery cells during the charging and discharging cycles, thus maintaining the electrical connection between the electrode and the printed circuit board. In other words, the combination of the curved central portion and the two planar ends extending parallel to one another ensures that the electrical connection is maintained during the charging and discharging cycles. In addition, the electrical connection between the battery cells is simplified by the fact that it is made directly by electrodes welded together, without the need for an additional element such as a busbar. The manufacture of a battery pack is therefore simplified.

The term “pouch battery cell” means that, in accordance with the usual meaning of this term in the field of batteries, the electrolyte and electrodes are accommodated in the internal space of the pouch battery cell, with a pouch-like envelope surrounding this internal space. The envelope includes, for example, an outer insulating layer, a metal layer, and optionally an inner adhesive layer. The insulating outer layer prevents the permeation of external moisture and/or gases, and is, for example, composed of a polymer material. The metal layer improves the envelope's mechanical strength. The metal layer is made of aluminum, for example. Alternatively, the metal layer is, for example, formed by an alloy of iron, carbon, chromium and manganese, or by steel, or by nickel, or by a nickel alloy, or by aluminum. The electrodes protrude from the envelope in the form of conductive tabs, the envelope being sealed around these conductive tabs, which thus form the electrodes of the pouch battery cell when the pouch battery cell is assembled. Preferably, the shape of the pouch battery cell is rectangular.

According to other optional features of the method for manufacturing a battery pack, taken either alone or in combination:
The printed circuit board comprises at least one slot, the strip being welded to an edge of a slot on the printed circuit board. This simplifies the positioning and subsequent welding of the strip to the printed circuit board.
The welding stages are carried out by laser welding. This simplifies manufacturing, not least because laser welding enables greater automation.
Each electrode is formed by a tongue extending initially, in other words prior to the production of each cell package, parallel to the main faces of the pouch battery cell.
Each positive electrode is made of aluminum, and each negative electrode is made of copper.
The first cell package and the second cell package are folded one on top of the other along a stacking axis E.
In the battery pack, the battery cells are stacked along the stacking axis E.
The printed circuit board, or PCB, forms part of a monitoring and/or control circuit for the battery pack.
The battery cells are slidably mounted along the stacking axis E with respect to the printed circuit board.
The strip is metal-based, preferentially copper.
The strip is a metal blade. The use of a metal blade simplifies manufacturing and makes it particularly easy to ensure that the electrical connection between the electrode and the printed circuit board is maintained during the charging and discharging cycles.
The strip forms part of a flexible printed circuit board. This makes strip production particularly simple and inexpensive, and simplifies strip positioning and welding.
After the strip welding step, the two ends of the strip extend parallel to one another. Preferably, the two ends of the strip extending parallel to one another are coplanar.
The strip is welded at one end to a negative electrode. Welding is simplified when the material of the strip and the negative electrode is similar, i.e. copper.
Both ends of the strip run perpendicular to the stacking axis E. In this way, compensation for the relative movement of the battery cells and the printed circuit board, due to the swelling and then deflation of the battery cells during the charging and discharging cycles, is optimally achieved by the central portion of the strip.
The central portion of the strip is curved only when being bent, so that movement of the battery cells along the stacking axis E is compensated for by the curvature of the central portion.
The central portion of the strip is curved in the shape of a loop. The function of such a loop is to absorb the thermal expansion of the battery cells in a particularly simple way.
The electrically conductive strip is connected on the printed circuit board side to a temperature sensor, preferably a negative temperature coefficient (NTC) thermistor.
Each cell package is made by stacking a plurality of battery cells.
In the step of making each cell package, the cell package is made by stacking a plurality of battery cells along a stacking axis E, and the same-sign electrodes of the battery cells of the cell package are welded directly to one another.
In the step of making each cell package, one electrode of a first battery cell is folded, brought into contact with, and then welded directly to a central portion of a same-sign electrode of a second battery cell, so that one end portion of the electrode of the second battery cell remains free, and the other electrode of the second battery cell is folded, brought into contact with, and then welded directly to a central portion of a same-sign electrode of the first battery cell, so that one end portion of the electrode of the first battery cell remains free.
Each cell package is made by stacking a plurality of battery cells along a stacking axis E, with a layer of compressible material and/or a heat dissipation plate being interposed between two adjacent battery cells, so that each battery cell of the cell package is framed at most by a layer of compressible material and by a heat dissipation plate. “Layer of compressible material” means in particular that the layer of compressible material is more compressible along the stacking axis E than the other elements of the cell package, namely the first battery cell and the second battery cell.
The methods comprises the following step: arranging a layer of compressible material and/or a heat dissipation plate between the first cell package and the second cell package, prior to the step of folding the first cell package and the second cell package onto one another, so that each battery cell of the battery pack is framed by a layer of compressible material and a heat dissipation plate.
The battery cells are identical and the cell packages are identical. This simplifies manufacturing, since there is no need to sort the battery cells or cell packages.
One end of an electrode of a battery cell of the first cell package is welded directly to one end of an opposite-sign electrode of a battery cell of the second cell package in order to electrically connect the first cell package and the second cell package in series.

The invention also relates to a battery pack obtained by the method as defined above. Such a battery pack comprises:
a first cell package, which is formed of at least one battery cell,
a second cell package, which is formed of at least one battery cell, each battery cell being in the form of a pouch and comprising two electrodes facing one another,
one electrode of a battery cell of the first cell package and one opposite-sign electrode of a battery cell of the second cell package are welded directly to one another, so that the first cell package and the second cell package are electrically connected in series,
the first cell package and the second cell package being folded on top of one another so that a folding of these two electrodes is achieved,
a printed circuit board,
an electrically conductive strip welded between one electrode of a battery cell of a cell package and the printed circuit board,
the electrically conductive strip being welded at one end to the electrode and at the other end to the printed circuit board, a central portion of the strip being curved, the two ends being planar and extending parallel to one another.

According to other optional features of the battery module taken either alone or in combination:
The battery pack comprises a housing accommodating the cell packages.
The printed circuit board is attached to the housing.
The housing comprises means for compressing the battery cells.
Each cell package comprises two battery cells, which are electrically connected in parallel.
Each cell package comprises a battery cell.
The battery pack comprises at least two cell packages, preferably the battery pack comprises more than twenty cell packages, more preferentially the battery pack comprises twenty-four cell packages, which are electrically connected in series.
The rated voltage delivered by each battery cell is around 4 V.

A further object of the invention is a battery system comprising at least two battery packs as defined above, wherein two battery packs share a single printed circuit board. This simplifies manufacturing, since a single printed circuit board is common to two battery packs.

According to other optional features of the battery system, taken either alone or in combination:
The battery system is a static electrical energy storage system, also known by the acronym ESS for “Energy Static Storage”.
The rated voltage delivered by the battery system is around 1500 V.

### BRIEF DESCRIPTION OF THE FIGURES

The invention will be better understood upon reading the following description, which is provided merely as example and with reference to the appended drawings, wherein:

FIG. 1 is a schematic front view of a system comprising two battery systems according to a first embodiment;

FIG. 2 is a schematic top view of the battery system shown in FIG. 1;

FIG. 3 is a schematic top view of part of a battery pack according to the first embodiment, i.e. of two cell packages, before their finalization, each cell package consisting of two pouch battery cells;

FIG. 4 is a schematic top view of the two cell packages shown in FIG. 3, once produced;

FIG. 5 is a schematic top view of the two cell packages shown in FIG. 4, electrically connected in series;

FIG. 6 is a schematic top view of the two cell packages shown in FIG. 5, folded atop one another;

FIG. 7 is a schematic top view of a system comprising two battery systems according to a second embodiment;

FIG. 8 is a schematic top view of part of a battery pack according to the second embodiment, i.e. of two cell packages, each cell package consisting of one pouch battery cell;

FIG. 9 is a schematic top view of the two cell packages shown in FIG. 8, electrically connected in series;

FIG. 10 is a schematic top view of the two cell packages shown in FIG. 9;

FIG. 11 is a schematic top view of a battery system comprising two battery packs according to a variant of the second embodiment shown in FIG. 7.

### DETAILED DESCRIPTION

In all the figures, the same references relate to the same elements.

In this detailed description, the following embodiments are examples. Although the description refers to one or more embodiments, this does not mean that the features apply only to a single embodiment. Simple features of different embodiments can also be combined and/or interchanged to provide other embodiments.

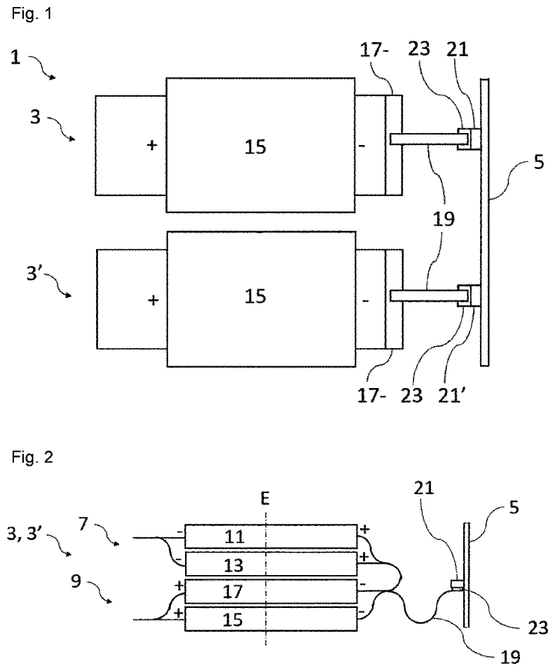

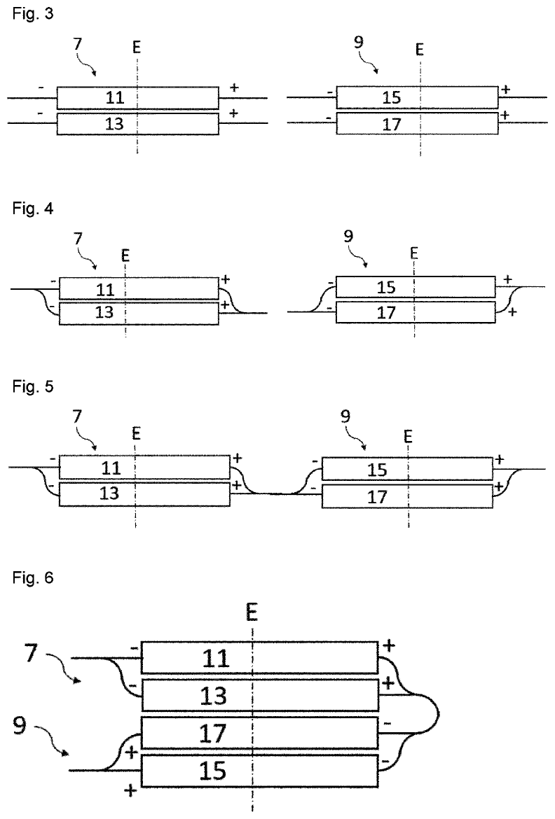

FIGS. 1 and 2 show a battery system 1 comprising two battery packs 3, 3′ in a first embodiment, the manufacturing steps of which are shown in FIGS. 3 to 6.

FIG. 1 schematically shows a battery system 1, comprising at least two battery packs 3, 3′ and a printed circuit board 5. The battery system 1 is, for example, a static electrical energy storage system. The rated voltage delivered by the battery system is, for example, around 1500 V. In this example, the two battery packs 3, 3′ share a single printed circuit board 5, so that the printed circuit board 5 is common to both battery packs 3. The printed circuit board 5 forms part of a monitoring and/or control circuit for the battery pack 3, 3′. Alternatively, and according to a variant not shown, each battery pack 3, 3′ may have its own printed circuit board.

In this example, battery packs 3, 3′ are identical, and each battery pack 3, 3′ comprises two cell packages 7, 9, shown in particular in FIG. 2. For the sake of simplicity, only two cell packages 7, 9 are shown here, but the person skilled in the art will readily understand that each battery pack 3, 3′ may comprise a larger number of cell packages, preferably more than twenty cell packages, more preferentially twenty-four cell packages, which are electrically connected in series. In this example, each cell package 7, 9 comprises two battery cells 11, 13, 15, 17. The rated voltage delivered by each battery cell 11, 13, 15, 17 is, for example, around 4 V.

The construction of the first cell package 7 and second cell package 9 is described below and shown in FIGS. 3 and 4. The first cell package 7 comprises two pouch battery cells 11, 13, and the second cell package also comprises two pouch battery cells 15, 17. In this example, the battery cells 11, 13, 15, 17 are identical. Each battery cell 11, 13, 15, 17 comprises two electrodes facing one another, specifically a positive electrode or cathode, referred to as ‘+’, and a negative electrode or anode, referred to as ‘−’. Each ‘+’, ‘−’ electrode is formed by a tongue that initially, in other words prior to the production of each cell package 7, 9, extends parallel to the main faces of the pouch battery cell. Each positive ‘+’ electrode is made, for example, of aluminum, and each negative ‘−’ electrode is made, for example, of copper. For the sake of simplicity, in the following description the electrode of a battery cell is indicated together with the battery cell reference, e.g. electrode 11+ for the positive ‘+’ electrode of battery cell 11.

In order to produce each cell package 7, 9, the cell package 7, 9 is made by stacking a plurality of battery cells, in this example two battery cells 11, 13, 15, 17, along a stacking axis E, as shown in FIG. 3.

Then, as shown in FIG. 4, the same-sign electrodes 11+, 13+, 11−, 13−, 15+, 17+, 15−, 17− of the battery cells 11, 13, 15, 17 of the cell package 7, 9 are welded directly together, for example by laser welding. More specifically, an electrode 11+, 17+ of a first battery cell 11, 17 is folded, brought into contact with, and then welded directly to a central portion of a same-sign electrode 13+, 15+ of a second battery cell 13, 15, so that one end portion of the electrode 13+, 15+ of the second battery cell remains free, and the other electrode 13−, 15− of the second battery cell 13, 15 is folded, brought into contact with, and then welded directly to a central portion of a same-sign electrode 11−, 17− of the first battery cell 11, 17, so that one end portion of the electrode 11−, 17− of the first battery cell remains free. Thus, each cell package 7, 9 comprises two battery cells 11, 13, 15, 17, which are electrically connected in parallel.

Then, as shown in FIG. 5, the first cell package 7 and the second cell package 9 are aligned, with an electrode 13+ of a battery cell 13 of the first cell package 7 and an opposite-sign electrode 17− of a battery cell 17 of the second cell package 9 lying on top of one another, and these two electrodes 13+, 17− are welded directly to one another, for example, by laser welding. In this way, the first cell package 7 and the second cell package 9 are electrically connected in series. More specifically, in this example, one end of an electrode 13+ of a battery cell 13 of the first cell package 7 is welded directly to one end of an opposite-sign electrode 17− of a battery cell 17 of the second cell package 9 in order to electrically connect the first cell package 7 and the second cell package 9 in series.

After this, the first cell package 7 and the second cell package 9 are folded on top of one another, so that the two electrodes 13+, 17− are folded together. More precisely, the first cell package 7 and the second cell package 9 are folded one on top of the other along the stacking axis E. Thus, in battery pack 3, 3′, the battery cells 11, 13, 17, 15 are stacked along the stacking axis E.

According to a variant not shown, a layer of compressible material and/or a heat dissipation plate is interposed between two adjacent battery cells 11, 13, 15, 17, so that each battery cell 11, 13 of the cell package 7, 9 is framed at most by a layer of compressible material and by a heat dissipation plate. The layer of compressible material is configured to absorb expansion along the stacking axis E of the first battery cell 11, 17 and the second battery cell 13, 15, and the layer of compressible material is thermally insulating, such that it is configured to thermally protect the first battery cell 11, 17 and the second battery cell 13, 15 from one another. In this way, the layer of compressible material simultaneously and simply fulfills the function of absorbing the expansion of the battery cells 11, 13, 15, 17 and the function of thermally protecting the battery cells 11, 13, 15, 17 from one another.

The battery pack 3, 3′ typically comprises a housing, not shown, accommodating the cell packages 7, 9, the housing comprising means for compressing the battery cells 11, 13, 15, 17. The printed circuit board 5 is attached to the housing. For example, the printed circuit board 5 is screwed or snapped onto the housing. To enable them to swell and then deflate, the battery cells 11, 13, 15, 17 are slidably mounted along the stacking axis E relative to the printed circuit board 5.

In order to connect the battery cells 11, 13, 15, 17 to the printed circuit board 5, for example, for their control or monitoring, an electrically conductive strip 19 is arranged between an electrode 17-of a battery cell 17 of a cell package 9 and the printed circuit board 5, as shown in FIG. 2. For example, the strip 19 is a metal blade. In this example, the strip 19 is metal-based, more precisely, the strip 19 is made of copper. In a variant not shown, the strip 19 forms part of a flexible printed circuit board (flexible PCB).

Next, the strip 19 is welded, for example by laser welding, at one end to the electrode 17− and at the other end to the printed circuit board 5, a central portion of the strip 19 being curved, the two ends being planar and extending parallel to one another. More specifically, the central portion of the strip 19 is curved only when being bent, so that movement of the battery cells 11, 13, 15, 17 along the stacking axis E is compensated for by the curvature of the central portion. In this example, welding is simplified by the fact that the electrode 17− is a negative copper electrode and strip 19 is also made of copper. Thus, after the strip 19 welding step, the two ends of the strip 19 run parallel to one another, and are coplanar in this example, as can be seen in FIG. 2. In addition, both ends of the strip 19 extend perpendicularly to the stacking axis E. This way, the strip 19 compensates for the maximum movement of the battery cells 11, 13, 15, 17 in both directions along the stacking axis E. To achieve this, the printed circuit board 5 comprises at least one slot 21, 21′, with the strip 19 being welded to one edge of the slot 21, 21′ of the printed circuit board 5.

More precisely in this example, the electrically conductive strip 19 is connected, on the printed circuit board 5 side, to a temperature sensor 23, in this example a thermistor with a negative temperature coefficient.

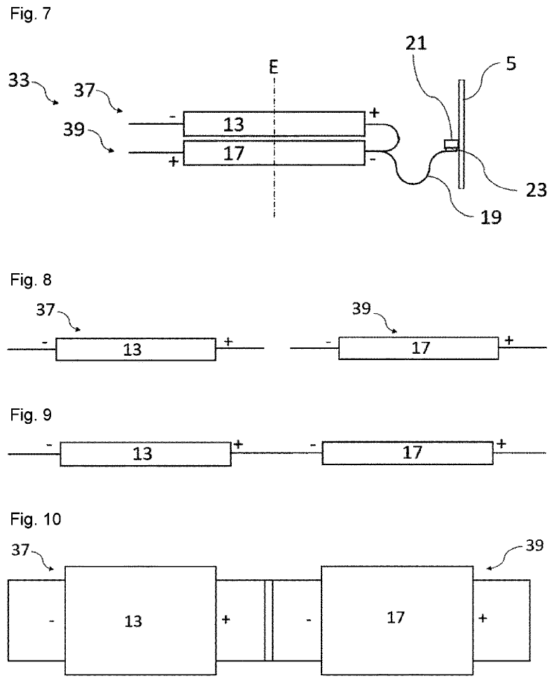

FIG. 7 schematically shows a battery pack 33 according to a second embodiment, the manufacturing steps of which are shown in FIGS. 8 to 10. This battery pack 33 according to the second embodiment differs from the battery pack 3, 3′ according to the first embodiment described above in that its two cell packages 37, 39 each consist of a single pouch battery cell 13, 17, as shown in FIG. 8.

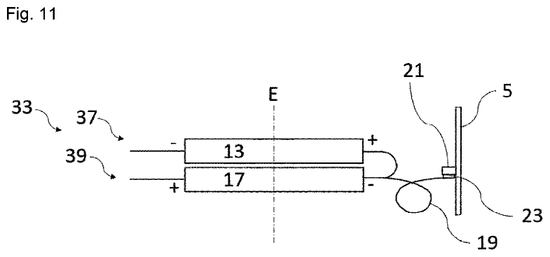

Then, as shown in FIGS. 9 and 10, the first cell package 37 and the second cell package 39 are aligned, with an electrode 13+ of the battery cell 13 of the first cell package 37 and an opposite-sign electrode 17− of the battery cell 17 of the second cell package 39 lying on top of one another, and these two electrodes 13+, 17− are welded directly to one another, for example, by laser welding. In this way, the first cell packet 37 and the second cell packet 39 are electrically connected in series. More specifically, in this example visible in FIG. 10, one end of an electrode 13+ of the battery cell 13 of the first cell package 37 is welded directly to one end of an opposite-sign electrode 17− of the battery cell 17 of the second cell package 39 in order to electrically connect the first cell package 37 and the second cell package 39 in series.

After this, the first cell package 37 and the second cell package 39 are folded on top of one another, so that the two electrodes 13+, 17− are folded together. More precisely, the first cell package 37 and the second cell package 39 are folded one on top of the other along the stacking axis E. Thus, in battery pack 33, the battery cells 13, 17, are stacked along the stacking axis E, as shown in FIG. 7.

In order to connect the battery cells 13, 17 to the printed circuit board 5, for example, for their control or monitoring, an electrically conductive strip 19 is arranged between an electrode 17− of the battery cell 17 of a cell package 39 and the printed circuit board 5, as shown in FIG. 7. In this example, the strip 19 is metal-based, more precisely, the strip 19 is made of copper. Next, the strip 19 is welded, for example by laser welding, at one end to the electrode 17− and at the other end to the printed circuit board 5, a central portion of the strip 19 being curved, the two ends being planar and extending parallel to one another. More specifically, the central portion of the strip 19 is curved only when being bent, so that movement of the battery cells 13, 17 along the stacking axis E is compensated for by the curvature of the central portion. In this example, welding is simplified by the fact that the electrode 17− is a negative copper electrode and strip 19 is also made of copper. Thus, after the strip 19 welding step, the two ends of the strip 19 run parallel to one another, and are coplanar in this example, as can be seen in FIG. 7. In addition, both ends of the strip 19 extend perpendicularly to the stacking axis E. This way, the strip 19 compensates for the maximum movement of the battery cells 13, 17 in both directions along the stacking axis E. To achieve this, the printed circuit board 5 comprises at least one slot 21, with the strip 19 being welded to one edge of the slot 21 of the printed circuit board 5.

More precisely in this example, the electrically conductive strip 19 is connected, on the printed circuit board 5 side, to a temperature sensor 23, in this example a thermistor with a negative temperature coefficient.

FIG. 11 schematically shows a battery pack 33 according to one variant of the second embodiment. This battery pack 33 according to this variant of the second embodiment differs from the battery pack 33 shown in FIG. 7 and described previously in that the central portion of the strip 19 is curved in the shape of a loop.

The invention is not limited to the embodiments presented, and other embodiments will become clearly apparent to the person skilled in the art. For the sake of simplicity, only two cell packages 7, 9 or 37, 39 are shown here, but the person skilled in the art will readily understand that each battery pack 3, 3′, 33 may comprise a larger number of cell packages, preferably more than twenty cell packages, more preferentially twenty-four cell packages, which are electrically connected in series. It is also possible to create a battery system with a larger number of battery packs, or to connect a plurality battery systems in series to increase the rated voltage that can be delivered.

### LIST OF REFERENCES

1: battery system
3, 3′: battery pack
5: printed circuit board
7, 9: cell package
11, 13, 15, 17: battery cell
19: strip
21, 21′: slot
23: temperature sensor
33: battery pack
37, 39: cell package
E: stacking axis
−: negative electrode
+: positive electrode

1. A method for manufacturing a battery pack, comprising:
providing pouch battery cells, each battery cell comprising two electrodes facing one another,
creating a first cell package, which is formed of at least one battery cell,
creating a second cell package, which is formed of at least one battery cell,
aligning the first cell package and the second cell package, with one electrode of a battery cell of the first cell package and an opposite-sign electrode of a battery cell of the second cell package lying on top of one another, directly welding these two electrodes to one another, so that the first cell package and the second cell package are electrically connected in series, and folding the first cell package and the second cell package onto one another so that these two electrodes are folded,
providing a printed circuit board,
arranging an electrically conductive strip between one electrode of a battery cell of a cell package and the printed circuit board,
welding the electrically conductive strip at one end to the electrode and at the other end to the printed circuit board, a central portion of the strip being curved, the two ends being planar and extending parallel to one another.

2. The method according to claim 1, wherein the printed circuit board comprises at least one slot, the strip being welded to an edge of a slot of the printed circuit board.

3. The method according to claim 1, wherein, after the step of welding the strip, the two ends of the strip are coplanar.

4. The method according to claim 1, wherein, in the step of making each cell package, the cell package is made by stacking a plurality of battery cells along a stacking axis, and the same-sign electrodes of the battery cells of the cell package are welded directly to one another.

5. The method according to claim 4, wherein, during the step of making each cell packet, an electrode of a first battery cell is folded, brought into contact with, and then welded directly to a central portion of a same-sign electrode of a second battery cell, so that one end portion of the electrode of the second battery cell remains free, and the other electrode of the second battery cell is folded, brought into contact with, and then welded directly to a central portion of a same-sign electrode of the first battery cell, so that one end portion of the electrode of the first battery cell remains free.

6. The method according to claim 1, wherein each cell package is produced by stacking a plurality of battery cells along a stacking axis, a layer of compressible material and/or a heat dissipation plate being interposed between two adjacent battery cells, so that each battery cell of the cell package is framed at most by a layer of compressible material and by a heat dissipation plate.

7. The method according to claim 1, wherein the battery cells are identical and wherein the cell packages are identical.

8. The method according to claim 1, wherein one end of an electrode of a battery cell of the first cell package is welded directly to one end of an opposite-sign electrode of a battery cell of the second cell package in order to electrically connect the first cell package and the second cell package in series.

9. The method according to claim 1, wherein the strip is a metal blade.

10. The method according to claim 1, wherein the strip is made of copper.

11. The method according to claim 1, wherein the strip forms part of a flexible printed circuit board.

12. The method according to claim 1, wherein the central portion of the strip is curved in the shape of a loop.

13. A battery pack obtained by the method according to claim 1, comprising:
a first cell package, which is formed of at least one battery cell,
a second cell package, which is formed of at least one battery cell,
each battery cell being in the form of a pouch and comprising two electrodes facing one another, one electrode of a battery cell of the first cell package and one opposite-sign electrode of a battery cell of the second cell package are welded directly to one another, so that the first cell package and the second cell package are electrically connected in series,
the first cell package and the second cell package being folded on top of one another so that a folding of these two electrodes is achieved,
a printed circuit board,
an electrically conductive strip, welded between one electrode of a battery cell of a cell package and the printed circuit board,
the electrically conductive strip being welded at one end to the electrode and at the other end to the printed circuit board, a central portion of the strip being curved, the two ends being planar and extending parallel to one another.

14. A battery system comprising at least two battery packs according to claim 13, wherein two battery packs share a single printed circuit board.

15. The method according to claim 2, wherein, after the step of welding the strip, the two ends of the strip are coplanar.

16. The method according to claim 2, wherein, in the step of making each cell package, the cell package is made by stacking a plurality of battery cells along a stacking axis, and the same-sign electrodes of the battery cells of the cell package are welded directly to one another.

17. The method according to claim 16, wherein, during the step of making each cell packet, an electrode of a first battery cell is folded, brought into contact with, and then welded directly to a central portion of a same-sign electrode of a second battery cell, so that one end portion of the electrode of the second battery cell remains free, and the other electrode of the second battery cell is folded, brought into contact with, and then welded directly to a central portion of a same-sign electrode of the first battery cell, so that one end portion of the electrode of the first battery cell remains free.

18. The method according to claim 2, wherein each cell package is produced by stacking a plurality of battery cells along a stacking axis, a layer of compressible material and/or a heat dissipation plate being interposed between two adjacent battery cells, so that each battery cell of the cell package is framed at most by a layer of compressible material and by a heat dissipation plate.

19. The method according to claim 2, wherein the battery cells are identical and wherein the cell packages are identical.
